(19) United States
(12) Patent Application Publication
(10) Pub. No.: US 2003/0119438 A1
(43) Pub. Date: Jun. 26, 2003

(54) Size-changeable coin bank

(76) Inventor: Dong-Hwan Chung, Pusan-City (KR)

Correspondence Address: BURNS DOANE SWECKER & MATHIS L L P, POST OFFICE BOX 1404, ALEXANDRIA, VA, 22313-1404, US

(21) Appl. No.: 10/022,240

(22) Filed: Dec. 20, 2001

(51) Int. Cl. G07D 9/00; G07D 9/04

(52) U.S. Cl. 453/60

(57) ABSTRACT

A size-changeable coin bank for counting coins comprises a main body having a cylinder with a coin slot and a funnel with a coin slot, the funnel screw-jointed to the cylinder, a counting cylinder inserted into the funnel and moved up and down, the counting cylinder having an open bottom, a scale marked on the outer surface and a metal lid attached to the top surface, wherein coins are inserted into the counting cylinder through the metal lid, and an ornament attached to the metal lid screw-jointed to the counting cylinder and having a metal coin. Herein the size of the coin bank is changeable by moving the counting cylinder up and down. The main body and/or the counting cylinders are polygonal. The cylinder, the funnel and the counting cylinders are made of a transparent material, and an advertisement paper or film is inserted into the inner or attached to the outer of the cylinder, the funnel and the counting cylinders. The coin bank further comprises a sensor or an IC chip for making a sound and lighting.

### BACKGROUND OF THE INVENTION

1. Field of the Invention

The present invention relates to a coin bank, and more particularly to a size-changeable coin bank, which sorts and counts coins, with various ornaments such as dolls, animals or other character models.

2. Description of the Prior Art

Usually, conventional coin banks for depositing coins comprise a main body in various shapes such as animals or other characters and a coin slot. Various coins are unsorted and collectively deposited within the coin bank. Therefore, the conventional coin banks are inconvenient to sort and count coins of varying diameters, i.e., 10 won, 50 won, 100 won and 500 won. Further, the conventional coin banks are not sufficient as decorations.

### SUMMARY OF THE INVENTION

Accordingly, an object of the present invention is to provide a coin bank comprising a counting cylinder with a coin slot detachably attached to a min body, thereby resulting in serving as a counting means after collecting coins.

Another object of the present invention is to provide a coin bank, whose size is changeable by moving the counting cylinder up and down.

Still another object of the present invention is to provide an ornamental coin bank with an ornament such as animal shapes or varying decorations attached to the upper surface of the counting cylinder.

In order to achieve the foregoing and other objects, the present invention provides size-changeable coin bank for counting coins, comprising a main body having a cylinder with a coin slot and a funnel with a coin slot, the funnel screw-jointed to the cylinder, a counting cylinder inserted into the funnel and moved up and down, the counting cylinder having an open bottom, the scale marked on the outer surface and a metal lid attached to the top surface, wherein coins are inserted into the counting cylinder through the metal lid, and an ornament attached to the metal lid screw-jointed to the counting cylinder and having a metal coin. Herein the size of the coin bank is changeable by moving the counting cylinder up and down.

In another aspect of the present invention, a size-changeable coin bank for counting coins comprises a main body having a plurality of cylinders, each with a closed bottom and an open top and screw-jointed to each other, and a funnel screw-jointed to the uppermost cylinder, a central counting cylinder screw-jointed to the top of the funnel, the central counting cylinder having the scale marked on the outer surface for counting at least one types of the coins, side counting cylinders formed on both side of the central counting cylinder and screw-jointed to the top of the funnel, and an ornament screw-jointed to the top surfaces of the central and side counting cylinders and having a body with a inner cavity and a coin slot, and a funnel detachably attached to the body of the ornament by an interconnection means.

The main body and/or the counting cylinders are polygonal.

Preferably, the cylinder, the funnel and the counting cylinders are made of a transparent material, and an advertisement paper or film is inserted into the inner or attached to the outer of the cylinder, the funnel and the counting cylinders. Further, the coin bank further preferably comprises a sensor or an IC chip for making a sound and lighting.

### BRIEF DESCRIPTION OF THE DRAWINGS

These and other objects, features and advantages of the present invention will be readily understood with reference to the following detailed description thereof provided in conjunction with the accompanying drawings, wherein like reference numerals designate like structural elements, and, in which:

FIG. 1 is a perspective view of a coin bank in accordance with an embodiment of the present invention; and

FIG. 2 is a perspective view of a coin bank in accordance with another embodiment of the present invention.

### DETAILED DESCRIPTION OF THE PREFERRED EMBODIMENT

Preferred embodiments of the present invention will be described below with reference to the accompanying drawings.

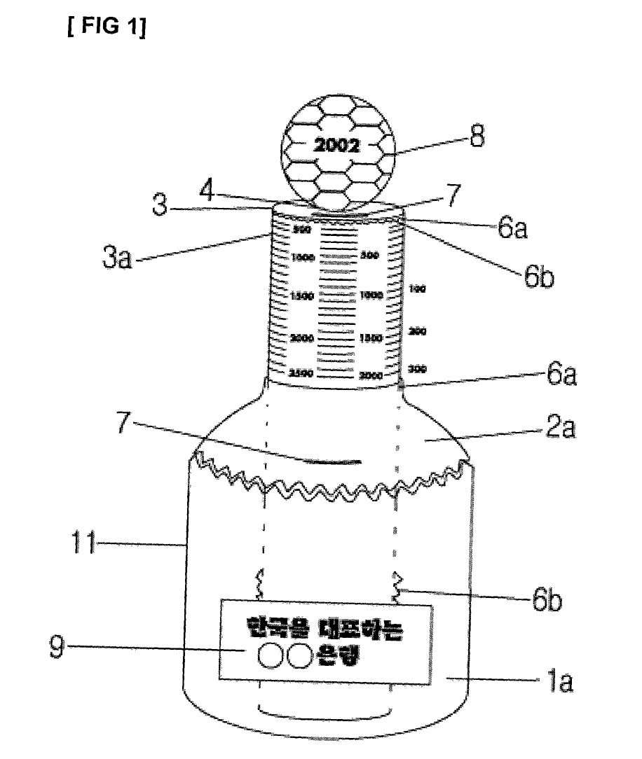

FIG. 1 is a perspective view of a coin bank in accordance with an embodiment of the present invention.

As shown in FIG. 1, a coin bank of an embodiment of the present invention comprises a main body 11 having a cylinder 1a with a closed bottom and a funnel 2a, a transparent counting cylinder 3a having an external screw 6a formed at the bottom surface and a metal lid 3 with a coin slot 7 screw-jointed to the top surface, and an ornament 8. The main body 11 is made of a transparent synthetic resin, a wood, or a steel. The main body 11 and the counting cylinder 3a may be cylindrical or polygonal, except for the screw-jointed area.

An internal screw 6a is formed on the top surface of the cylinder 1a, and an external screw 6b is formed on the bottom surface of the funnel 2a. The external screw 6b is detachably jointed to the internal screw 6a, thereby forming the main body 11.

An internal screw 6a is formed on the top surface of the funnel 2a.

The counting cylinder 3a is inserted into the top of the funnel 2a. Herein, the scale for representing the number of the deposited coins, i.e., by 10 won unit, by 100 won unit or by 500 won unit, is marked on the outer wall of the counting cylinder 3a. Prior to jointing the funnel 2a to the cylinder 1a, the counting cylinder 3a provided with the metal lid 3 is inserted into the top of the funnel 2a.

The bottom surface of the counting cylinder 3a with an external screw 6b has a diameter enough to be suitably jointed to an internal screw 6a of the top surface of the funnel 2a. Thereby, the counting cylinder 3a in a forward direction is not separated from the funnel 2a. However, after detaching the funnel 2a from the cylinder 1a of the main body 11, the counting cylinder 3a in a backward direction is separated from the funnel 2a.

Therefore, when the main body 11 is filled with coins, the counting cylinder 3a is pulled out, thereby resulting in additionally collecting more coins. After collecting coins, when the deposited coins are extracted to be counted, the counting cylinder 3a is separated from the funnel 2a in a backward direction and the internal screw 6a on the top of the funnel 2a is jointed to the external screw 6b of the counting cylinder 3a. Then, coins are stacked within the counting cylinder 3a. Therefore, the coin bank of the present invention easily counts the deposited coins.

An ornament 8 with a permanent magnet 4 attached to the bottom is attached to the top surface of the metal lid 3. For example, the ornament 8 may be a football or various animal decorations and magnetically attached to the metal lid 9.

An internal screw 6a is formed on the inner wall of the metal lid 3 and screw-jointed to the external screw 6b on the top of the counting cylinder 3a.

The coin slot 7 and a hole for receiving writing means such as pencils are formed on the outer surface of the funnel 2a. A film for advertisement may be attached to the outer surface of the cylinder 1a.

If the cylinder 1a is made of a transparent material, an elastic advertisement film 9 is put in the cylinder 1a and adhered closely to the inner wall of the cylinder 1a by pressing the deposited coins, thereby enhancing the commercial effect,

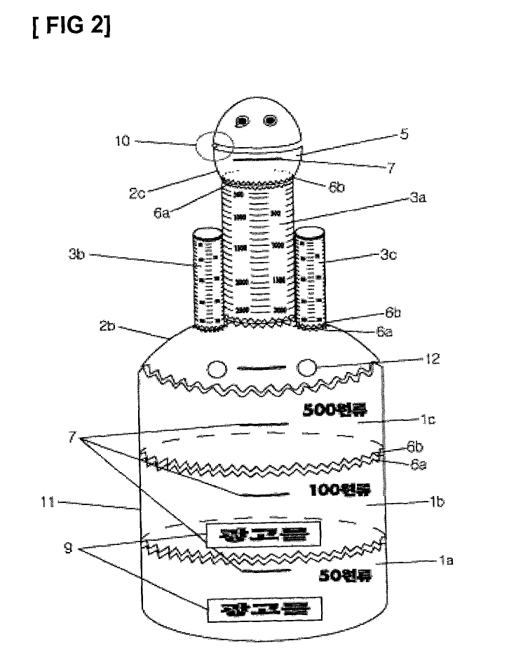

FIG. 2 is a perspective view of a coin bank in accordance with another embodiment of the present invention.

As shown in FIG. 2, the cylinder of the main body 11 comprises three parts 1a, 1b, and 1c, thereby sorting out coins of varying diameters into 50 won, 100 won and 500 won, and each cylinder 1a, 1b and 1c has a closed bottom surface and a coin slot 7 respectively. The lowermost cylinder 1a has an internal screw 6a on the top surface. The internal screw 6a of the lowermost cylinder 1a is jointed to the external screw 6b of the middle cylinder 1b. Also, the middle cylinder 1b has an internal screw 6a on the top surface, thereby jointed to the external screw 6b of the uppermost cylinder 1c.

The uppermost cylinder 1c has an internal screw 6a on the top surface. The external screw 6b of the bottom of a funnel 2b is jointed to the internal screw 6a of the uppermost cylinder 1c.

The funnel 2b has an internal screw 6a on the outer surface of the top of the funnel 2b. At least one counting cylinder 3a, 3b, and 3c with a closed bottom surface and an external screw 6b is screw-jointed to the funnel 2b. That is, the main body 11 and the counting cylinders 3a, 3b and 3c can collect and sort varying coins. An ornament 5 comprises a coin slot 7 and an inner cavity. The ornament 5 is detachably attached to a funnel 2c by an interconnection means 10. Thereby, after separating the ornament 5 from the funnel 2c, the deposited coins are stacked within the counting cylinder 3a through the funnel 2c, thereby calculating the total amount of the coins.

On both sides of the central counting cylinder 3a, side counting cylinders 3b and 3c with the scale marked on the outer surface are formed. The side counting cylinders 3b, 3c are also detachably screw-jointed to the funnel 2b.

The central counting cylinder 3a has an internal screw 6a on the top and the side counting cylinders 3b, 3c also has an internal screw 6a on the top, respectively. Various ornaments with a coin slot and inner cavity may be detachably attached to the side counting cylinders 3b, 3c by the interconnection means 10. In counting coins, the counting cylinders 3a, 3b and 3c are separated from the funnel 2b and the ornament 5 is separated from the counting cylinders 3a, 3b and 3c. Then the deposited coins are stacked within the counting cylinder 3a, 3b and 3c through the funnel 2c, thereby calculating the total amount of the coins.

As described above, the main body 11 and the counting cylinders 3a, 3b and 3c are made of a transparent material. Therefore, an elastic advertisement film 9 is inserted into or attached to the main body 11 and/or the counting cylinders 3a, 3b and 3c, thereby obtaining the commercial effect, Additionally, a sensor or IC chips for making a sound or lighting by the contact or the weight of the coins may be attached to the inner of the main body 11.

With the structure of the coin bank of the preferred embodiments of the present invention, the counting cylinder is screw-jointed to the main body and moves up and down, thereby variously changing the size of the coin bank.

Furthermore, the deposited coins are collectively sorted by types of the coins. Therefore, the present invention minimizes the time and effort of counting coins.

An advertisement paper or film is inserted into the inner or attached to the outer of the coin bank, thereby obtaining the commercial effect.

Moreover, an ornament such as a football or various animal decorations is attached to the coin bank, then providing an aesthetic appreciation and further encouraging children in savings.

Although the preferred embodiments of the present invention have been described in detail hereinabove, it should be understood that many variations and/or modifications of the basic inventive concepts herein taught which may appear to those skilled in the art will still fall within the spirit and scope of the present invention as defined in the appended claims.

What is claimed is:

1. A size-changeable coin bank for counting coins, said coin bank comprising:
a main body having a cylinder with a coin slot and a funnel with a coin slot, said funnel screw-jointed to said cylinder;
a counting cylinder inserted into said funnel and moved up and down, said counting cylinder having an open bottom, a scale marked on the outer surface and a metal lid attached to the top surface, wherein coins are inserted into said counting cylinder through said metal lid; and
an ornament attached to said metal lid screw-jointed to said counting cylinder and having a metal coin,
wherein the size of said coin bank is changeable by moving said counting cylinder up and down.

2. A size-changeable coin bank for counting coins, said coin back comprising:
a main body having a plurality of cylinders, each with a closed bottom and an open top and screw-jointed to each other, and a funnel screw-jointed to the uppermost cylinder;
a central counting cylinder screw-jointed to the top of said funnel, said central counting cylinder having a scale marked on the outer surface for counting at least one types of the coins;
side counting cylinders formed on both side of said central counting cylinder and screw-jointed to the top of said funnel; and
an ornament screw-jointed to the top surfaces of said central and side counting cylinders and having a body with a inner cavity and a coin slot, and a funnel detachably attached to the body of said ornament by an interconnection means.

3. The size-changeable coin bank for counting coins as claimed in claim 1 or claim 2, wherein said main body or said counting cylinders are polygonal.

4. The size-changeable coin bank for counting coins as claimed in claim 1 or claim 2, wherein said cylinder, said funnel and said counting cylinders are made of a transparent material, and an advertisement paper or film is inserted into the inner or attached to the outer of said cylinder, said funnel and said counting cylinders.

5. The size-changeable coin bank for counting coins as claimed in claim 1 or claim 2, further comprising a sensor or an IC chip for making a sound and lighting.
